(19) United States
(12) Patent Application Publication
(10) Pub. No.: US 2014/0174901 A1
(43) Pub. Date: Jun. 26, 2014

(54) Keyboard Button Structure

(71) Applicant: Compal Electronics, Inc., Taipei City (TW)

(72) Inventor: Chih-An Lin, Taipei City (TW)

(21) Appl. No.: 13/912,036

(22) Filed: Jun. 6, 2013

(30) Foreign Application Priority Data
Dec. 25, 2012 (TW) 101149835

(51) Int. Cl. H01H 13/54

(52) U.S. Cl. CPC H01H 13/54
USPC 200/535

(57) ABSTRACT

A keyboard button structure includes a flexible board and a key cap. The flexible board includes an hollow-out body, a first support portion, a second support portion, and an extending arm including a conducting contact. The first supporting is connected to the hollow-out body. A first perpendicular distance is formed between the first support portion and the hollow-out body. The second support portion is connected to the first support portion. The extending arm is connected to the second support portion. A second perpendicular distance is formed between the extending arm and the hollow-out body. The key cap is fixed to the first and the second support portions, and is rotatably coupled to the hollow-out body. When the key cap is moved in a direction toward the hollow-out body by an external force, the extending arm is moved in the direction with the key cap.

### RELATED APPLICATIONS

This application claims priority to Taiwan Application Serial Number 101149835, filed Dec. 25, 2012, which is herein incorporated by reference.

### BACKGROUND

1. Technical Field

The present disclosure relates to a button structure, and more particularly relates to a button structure used in a keyboard.

2. Description of Related Art

Keyboards are important input devices for operating computers, allowing users to input letters, symbols, or numbers. In addition, keyboard button structures are often utilized in consumer electronic products, as well as in industrial processing equipment, and enable users to input signals conveniently.

FIG. 1 is a cross-sectional view of a conventional keyboard button structure 100. As shown in FIG. 1, the conventional keyboard button structure 100 includes a key cap 110, a vertical moving member 120 (also referred to as a scissor structure), a flexible element 130, a printed circuit board 140, and a bottom board 150. The printed circuit board 140 is arranged on the bottom board 150. The vertical moving member 120 and the flexible element 130 are disposed between the key cap 110 and the bottom board 150. When the key cap 110 is pressed to move in a direction toward the printed circuit board 140, the flexible element 130 provides an elastic recovery force to the key cap 110, such that the key cap 110 can recover to an initial, non-pressed position.

Furthermore, the key cap 110 has a sliding groove 112 and an engaging groove 114. The bottom board 150 has a sliding groove 152 and an engaging groove 154. The vertical moving member 120 includes support stands 122, 124. Two ends of the support stand 122 are located in the sliding groove 112 and the engaging groove 154, respectively. Two ends of the support stand 124 are located in the sliding groove 152 and the engaging groove 114, respectively. As a result, the key cap 110 can move up and down through the vertical moving member 120.

However, since the vertical moving member 120 is fixed by the sliding groove 112 and the engaging groove 114 of the key cap 110, and by the sliding groove 152 and the engaging groove 154 of the bottom board 150, the structure of the conventional button structure 100 is complicated, and the key cap 110 easily rocks and is easily displaced. When a large external force is applied to the key cap 110, the key cap 110 may be separated form the vertical moving member 120, or the vertical moving member 120 may suffer damage caused by the external force.

### SUMMARY

An aspect of the present invention is to provide a keyboard button structure.

In an embodiment of the present invention, a keyboard button structure includes a flexible board and a key cap. The flexible board includes an hollow-out body, a first support portion, a second support portion, and an extending arm. The first support portion is connected to the hollow-out body. A first perpendicular distance is formed between the first support portion and the hollow-out body. The second support portion is connected to the first support portion. The extending arm is connected to the second support portion. A second perpendicular distance is formed between the extending arm and the hollow-out body. The extending arm includes a conducting contact. The key cap is fixed to the first and second support portions and rotatably coupled to the hollow-out body. When the key cap is moved in a direction toward the hollow-out body by an external force, the key cap is pivoted relative to the hollow-out body and contacts the extending arm, such that the extending arm is moved in the direction toward the hollow-out body at the same time.

In an embodiment of the present invention, a first opening groove is formed between the first support portion and the hollow-out body, and a second opening groove is formed between the second support portion and the hollow-out body.

In an embodiment of the present invention, the second perpendicular distance is smaller than or equal to the first perpendicular distance.

In an embodiment of the present invention, the hollow-out body has at least one engaging groove, and the key cap has at least one rotation axis coupled to the engaging groove, such that the key cap is rotatably coupled to the hollow-out body.

In an embodiment of the present invention, the key cap has a first protruding portion. The first support portion has a first through hole, and the first protruding portion is fixed in the first through hole.

In an embodiment of the present invention, the key cap has a second protruding portion. The second support portion has a second through hole, and the second protruding portion is fixed in the second through hole.

In an embodiment of the present invention, the hollow-out body has a plurality of third through holes. The keyboard button structure includes a bottom board and a printed circuit board. The bottom board has a plurality of third protruding portions. The printed circuit board has a plurality of fourth through holes, and is located between the flexible board and the bottom board. The third protruding portions are coupled to the third and fourth through holes. When the conducting contact contacts the printed circuit board, a pressing signal is generated by the printed circuit board.

In an embodiment of the present invention, each of the first and second support portions is substantially U-shaped.

In an embodiment of the present invention, the hollow-out body, the first and second support portions, and the extending arm are integrally formed as a single piece.

In an embodiment of the present invention, the flexible board is made of a material that includes copper or stainless steel.

In an embodiment of the present invention, the key cap is made of a material that includes plastic or metal.

In the aforementioned embodiments of the present invention, the key cap is fixed to the first and second support portions and rotatably coupled to the hollow-out body of the flexible board. Since the second perpendicular distance is smaller than or equal to the first perpendicular distance, when the key cap is pressed in a direction toward the hollow-out body by an external force, the key cap can be pivoted relative to the hollow-out body and contacts the extending arm. Next, the key cap and the extending arm are moved in the direction toward the hollow-out body at the same time, and a pressing signal is generated by the printed circuit board in response to the conducting contact contacting the printed circuit board.

The flexible board of the button structure can replace a conventional vertical moving member (also referred to as a scissor structure). Compared with the conventional vertical moving member, the flexible board is not easily damaged. Therefore, the lifespan of the button structure can be extended. Moreover, the key cap can be fixed to the first and second support portions by engaging, adhering, or heat melting methods, such that the key cap does not easily encounter rocking, separating, or displacement problems. Furthermore, when the second perpendicular distance is smaller than the first perpendicular distance, the key cap can contact the extending arm first, after which the conducting contact contacts the printed circuit board. As a result, users can experience a good tactile sensation when operating the keyboard button structure.

### BRIEF DESCRIPTION OF THE DRAWINGS

FIG. 1 is a cross-sectional view of a conventional keyboard button structure;

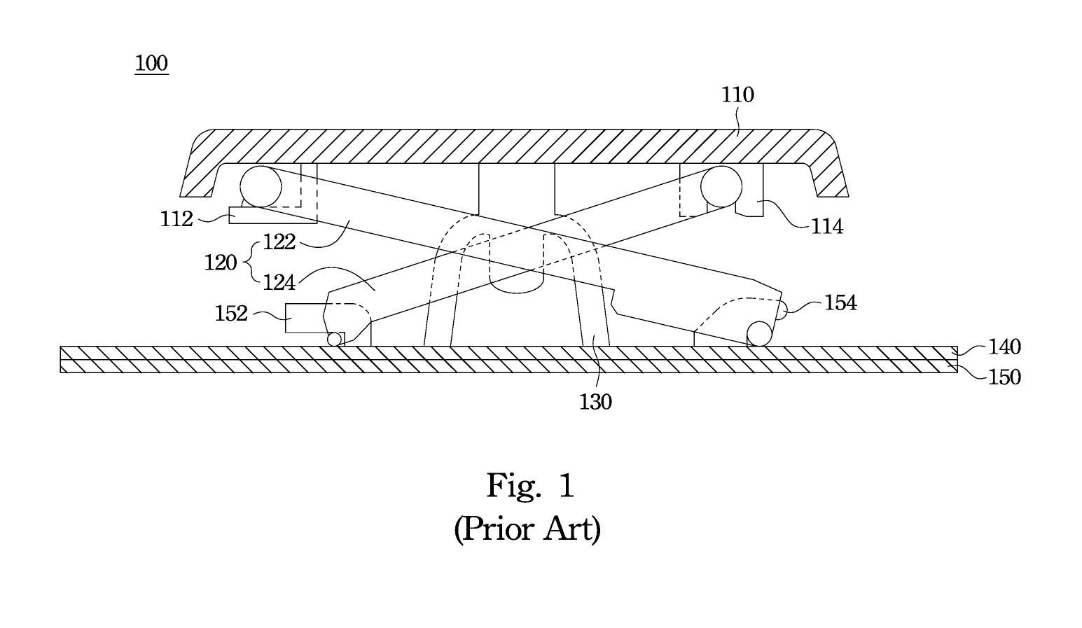

FIG. 2 is a perspective view of a keyboard button structure according to an embodiment of the present invention;

FIG. 3 is an exploded view of the keyboard button structure shown in FIG. 2;

FIG. 4 is a perspective view of a flexible board shown in FIG. 3;

FIG. 5A is a schematic view of a key cap shown in FIG. 3 when being assembled to the flexible board;

FIG. 5B is a perspective view of the key cap shown in FIG. 5A after being assembled to the flexible board;

FIG. 6 is a schematic view of a first protruding portion shown in FIG. 5B after being heat melted;

FIG. 7 is a cross-sectional view of the keyboard button structure taken along line 7-7′ shown in FIG. 2;

FIG. 8 is an enlarged view of a bottom board shown in FIG. 3;

FIG. 9 is an enlarged view of a printed circuit board shown in FIG. 3; and

FIG. 10 is partial bottom view of the keyboard button structure shown in FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

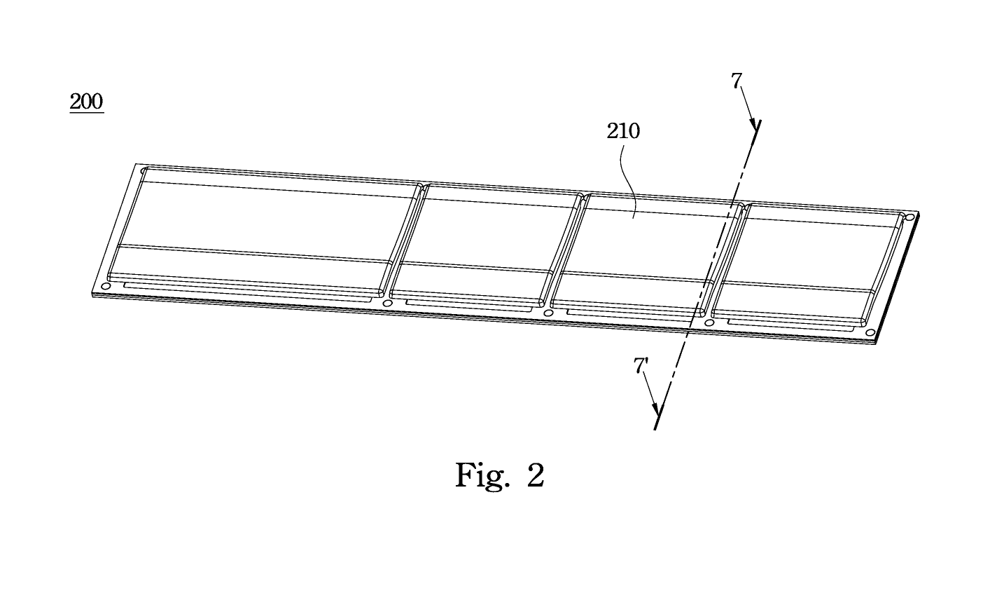

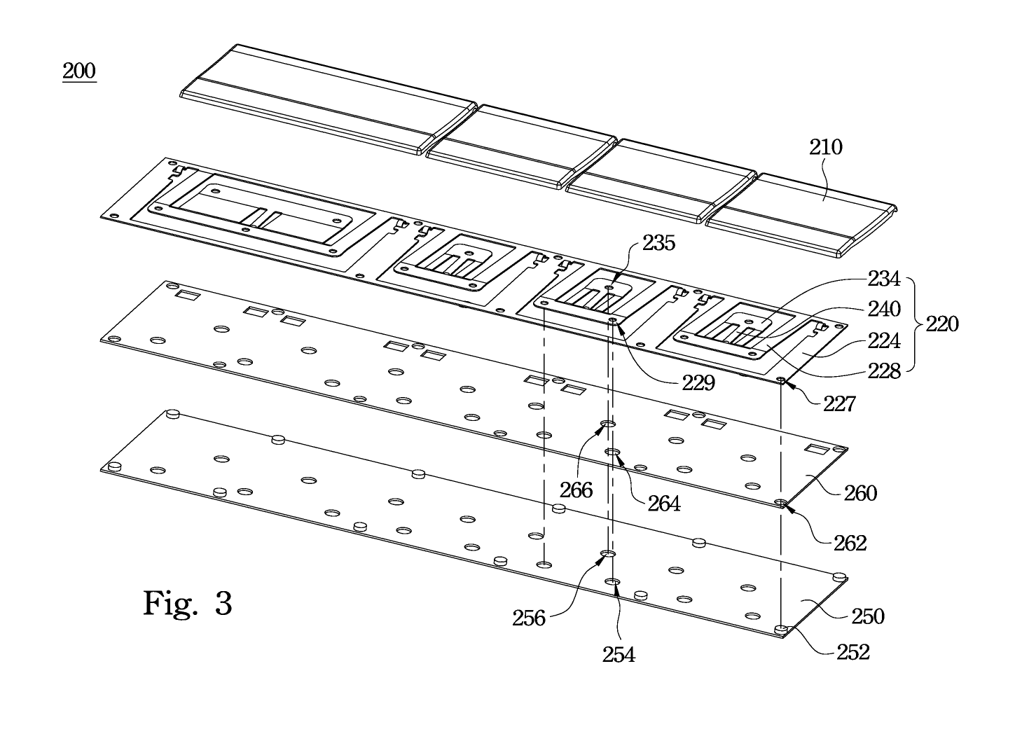

FIG. 2 is a perspective view of a keyboard button structure 200 according to an embodiment of the present invention. FIG. 3 is an exploded view of the keyboard button structure 200 shown in FIG. 2. As shown in FIG. 2 and FIG. 3, the keyboard button structure 200 includes a key cap 210, a flexible board 220, a bottom board 250, and a printed circuit board 260. In the drawings, although a plurality of elements may be shown, only one of each of the elements will be described to simplify the explanation to follow. For example, there may be a plurality of the key caps 210, as shown in FIGS. 2 and 3.

The key cap 210 is located on the flexible board 220, and the printed circuit board 260 is located between the flexible board 220 and the bottom board 250. In this embodiment, the flexible board 220 may be made of a material that includes copper or stainless steel. The key cap 210 may be made of a material that includes plastic or metal. The printed circuit board 260 may be a flexible printed circuit (FPC) board or an inflexible printed circuit board, but the present invention is not limited in this regard.

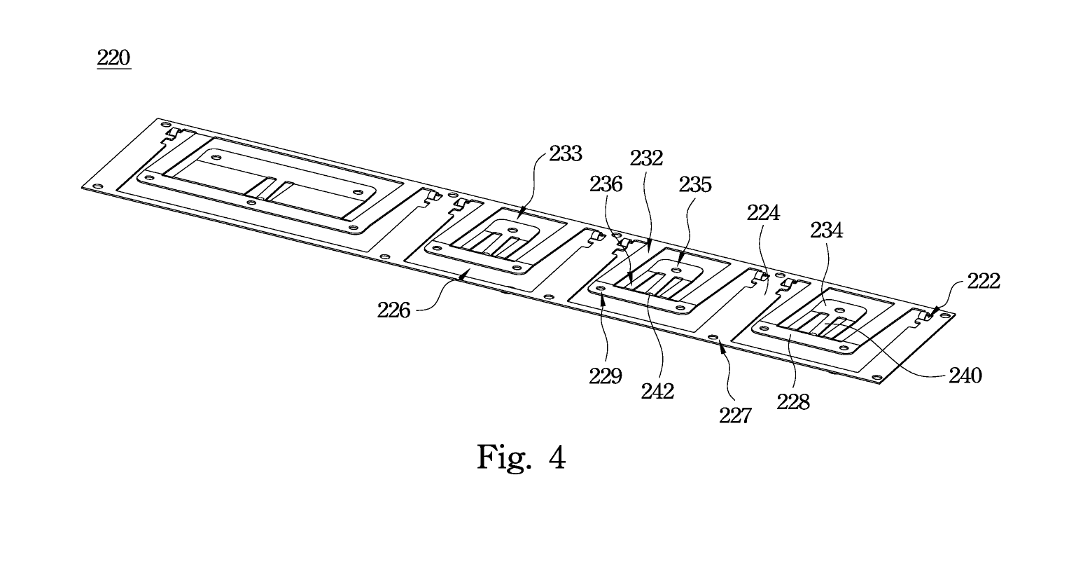

FIG. 4 is a perspective view of the flexible board 220 shown in FIG. 3. As shown in FIGS. 3 and 4, the flexible board 220 includes an hollow-out body 224, a first support portion 228, a second support portion 234, and an extending arm 240. The first support portion 228 has two parallel end portions 232 connected to the hollow-out body 224, such that a first opening groove 226 is formed between the first support portion 228 and the hollow-out body 224. The second support portion 234 has two parallel end portions 236 connected to the first support portion 228, such that a second opening groove 233 is formed between the second support portion 234 and the hollow-out body 224. The extending arm 240 is connected to the second support portion 234 and has a conducting contact 242.

In addition, the hollow-out body 224, the first and second support portions 228, 234, and the extending arm 240 may be integrally formed as a single piece. Each of the first and second support portions 228, 234 may be substantially U-shaped.

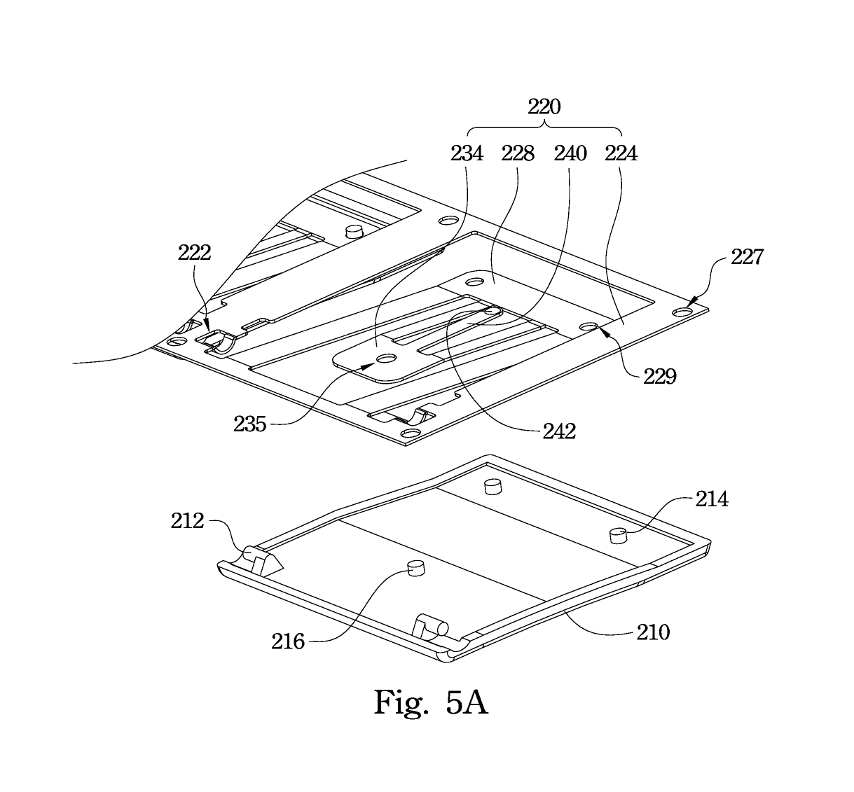

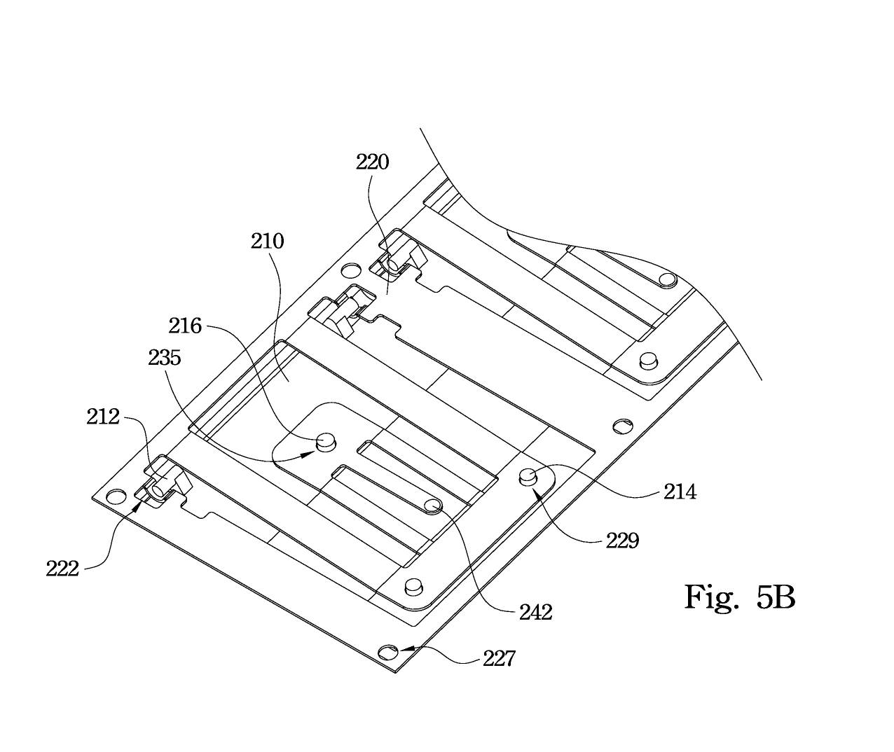

FIG. 5A is a schematic view of the key cap 210 shown in FIG. 3 when being assembled to the flexible board 220. FIG. 5B is a perspective view of the key cap 210 shown in FIG. 5A after being assembled to the flexible board 220. As shown in FIG. 5A and FIG. 5B, the hollow-out body 224 of the flexible board 220 has two substantially symmetric engaging grooves 222. The key cap 210 has two substantially symmetric rotation axes 212, a first protruding portion 214, and a second protruding portion 216. Furthermore, the first support portion 228 has a first through hole 229, and the second support portion 234 has a second through hole 235.

During assembly, the rotation axes 212 are respectively placed in the engaging grooves 222. Moreover, the first protruding portion 214 is inserted in the first through hole 229, and the second protruding portion 216 is inserted in the second through hole 235. As a result, the key cap 210 can be fixed to the first and second support portions 228, 234, and can be rotatably coupled to the hollow-out body 224. For example, the first protruding portion 214 may be fixed in the first through hole 229 by coupling, adhering, or heat melting methods, and the second protruding portion 216 may also be fixed in the second through hole 235 by coupling, adhering, or heat melting methods, such that the first and second protruding portions 214, 216 are respectively fixed to the first and second support portions 228, 234. Therefore, the key cap 210 does not easily encounter rocking, separating, or displacement problems. Depending on the design of the product to which the keyboard button structure 200 is applied, the rotation axes 212 may be disposed on the hollow-out body 224 of the flexible board 220, and the engaging grooves 222 may be formed in the key cap 210, but the present invention is not limited in this regard.

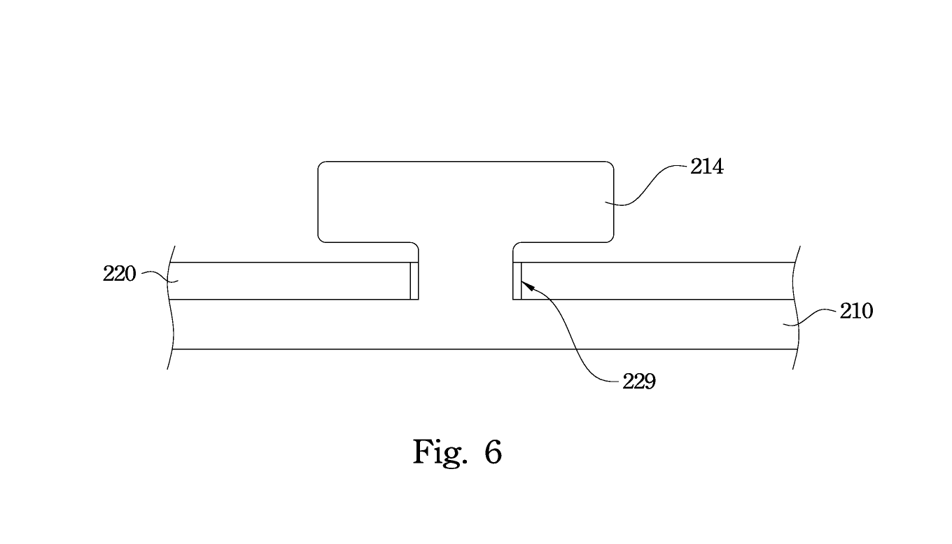

FIG. 6 is a schematic view of the first protruding portion 214 shown in FIG. 5B after being heat melted. In FIG. 6, although the first protruding portion 214 and the first through hole 229 are used as an example, this description may also apply to the second protruding portion 216 and the second through hole 235. In this embodiment, since the first protruding portion 214 may be made of a material that includes plastic or metal, an end of the first protruding portion 214 can be deformed by applying high temperature thereto, such that the first protruding portion 214 is fixed in the first through hole 229 and the key cap 210 is secured to the flexible board 220.

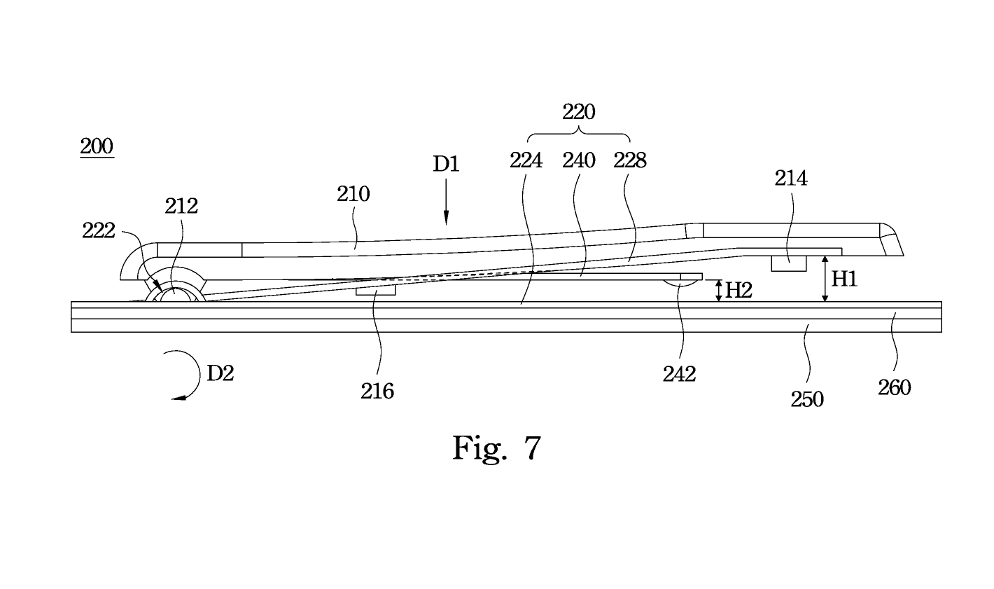

FIG. 7 is a cross-sectional view of the keyboard button structure 200 taken along line 7-7′ shown in FIG. 2. As shown in FIG. 7, the extending arm 240 includes the conducting contact 242 adjacent to the printed circuit board 260. A first perpendicular distance H1 is formed between the first support portion 228 and the hollow-out body 224, and a second perpendicular distance H2 is formed between the extending arm 240 and the hollow-out body 224. The second perpendicular distance H2 is smaller than or equal to the first perpendicular distance H1.

When the key cap 210 is pressed in a direction D1 toward the hollow-out body 224 by an external force, the key cap 210 can be pivoted relative to the hollow-out body 224 in a direction D2 by the rotation axes 212 located in the engaging grooves 222 (only one rotation axis 212 and one engaging groove 222 are shown in FIG. 7). Next, the key cap 210 contacts the extending arm 240. Thereafter, the key cap 210 and the extending arm 240 are moved in the direction D1 toward the hollow-out body 224 at the same time, and the conducting contact 242 can contact the printed circuit board 260, such that a pressing signal is generated and inputted to a system of an electronic device (not shown). After the external force is removed, the key cap 210 can recover to an initial, non-pressed position due to the flexibility of the first and second support portions 228, 234 (see FIG. 5A) and the extending arm 240. That is to say, the flexible board 220 can replace a conventional vertical moving member (also referred to as a scissor structure). Compared with the conventional vertical moving member, the flexible board 220 is not easily damaged. Therefore, the lifespan of the keyboard button structure 200 can be extended. Moreover, when the second perpendicular distance H2 is smaller than the first perpendicular distance H1, the key cap 320 can contact the extending arm 240 first, after which the conducting contact 242 contacts the printed circuit board 260. As a result of such a design, users can experience a good tactile sensation when operating the keyboard button structure.

It is to be noted that the connection relationships of the elements described above will not be repeated in the following description, and only aspects related to the connection relationships between the flexible board 220, the printed circuit board 260, and the bottom board 250 will be described.

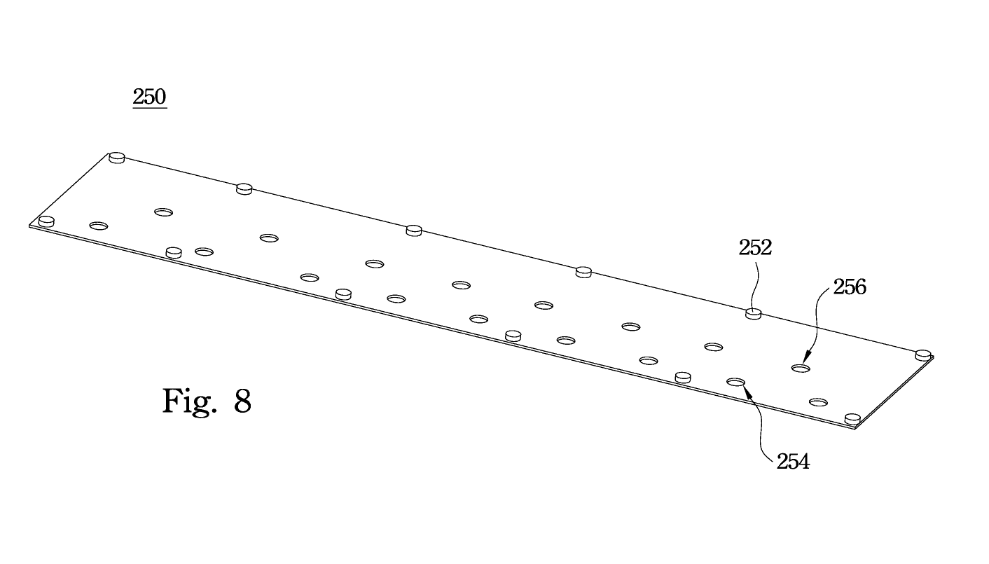

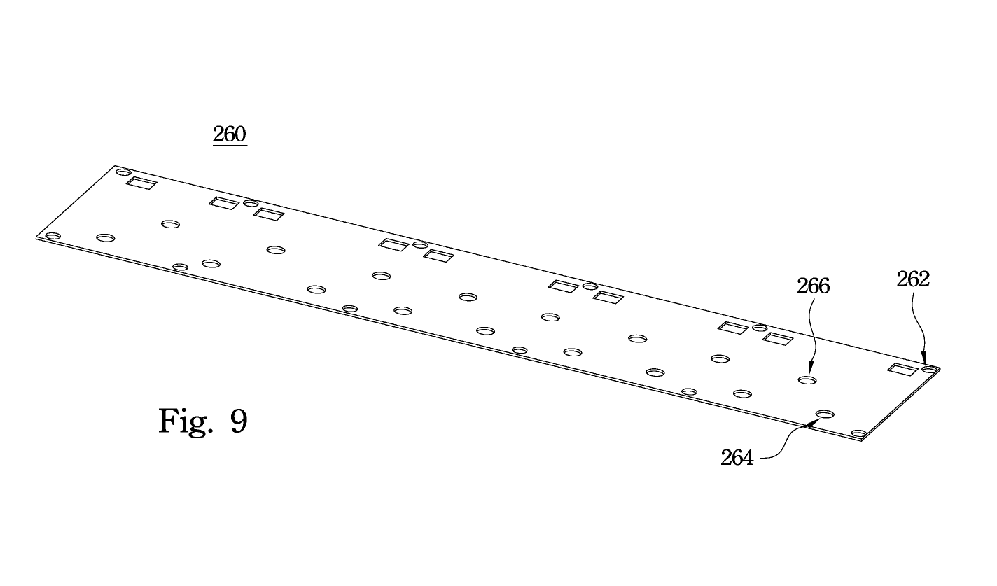

FIG. 8 is an enlarged view of the bottom board 250 shown in FIG. 3. FIG. 9 is an enlarged view of the printed circuit board 260 shown in FIG. 3. As shown in FIG. 3, FIG. 8, and FIG. 9, the hollow-out body 224 may have a plurality of third through holes 227. The bottom board 250 may have a plurality of third protruding portions 252. The printed circuit board 260 may have a plurality of fourth through holes 262. During assembly, the third protruding portions 252 can be inserted in the third and fourth through holes 227, 262, such that the flexible board 220 and the printed circuit board 260 are secured on the bottom board 250.

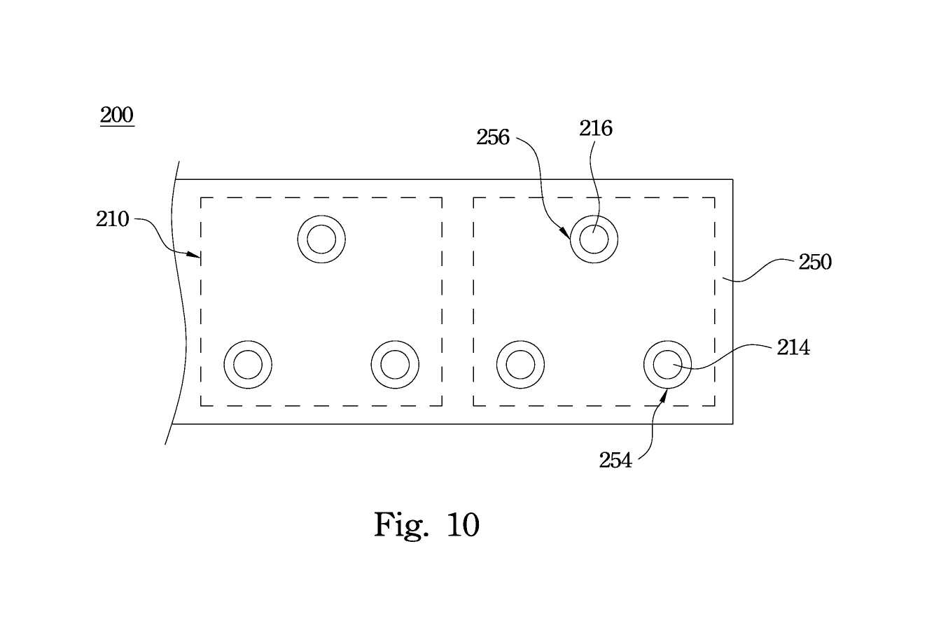

FIG. 10 is partial bottom view of the keyboard button structure 200 shown in FIG. 2. As shown in FIG. 3 and FIG. 10, the bottom board 250 may further have a fifth through hole 254, and the printed circuit board 260 may further have a sixth through hole 264. The fifth through hole 254, the sixth through hole 264, and the first through hole 229 are aligned with each other. Furthermore, the bottom board 250 may further have a seventh through hole 256, and the printed circuit board 260 may further have an eighth through hole 266. The seventh through hole 256, the eighth through hole 266, and the second through hole 235 are aligned with each other.

Referring to FIG. 5B at the same time, after the key cap 210, the flexible board 220, the bottom board 250, and the printed circuit board 260 are assembled, the position of the first protruding portion 214 is substantially aligned with the fifth and sixth through holes 254, 264, and the second protruding portion 216 is substantially aligned with the seventh and eighth through holes 256, 266.

As a result, when the key cap 210 is damaged and needs to be changed, a technician can conveniently perform a process on the first protruding portion 214 (e.g., use tools to remove heat melting points or adhesives) via the fifth and sixth through holes 254, 264, such that the first protruding portion 214 can be separated from the first through hole 229. Similarly, the technician can also conveniently perform a process on the second protruding portion 216 via the seventh and eighth through holes 256, 266, such that the second protruding portion 216 can be separated from the second through hole 235.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A keyboard button structure comprising:
a flexible board comprising:
an hollow-out body;
a first support portion connected to the hollow-out body, wherein a first perpendicular distance is formed between the first support portion and the hollow-out body;
a second support portion connected to the first support portion; and
an extending arm connected to the second support portion, wherein a second perpendicular distance is formed between the extending arm and the hollow-out body, and the extending arm comprises a conducting contact; and
a key cap fixed to the first and second support portions and rotatably coupled to the hollow-out body, wherein when the key cap is moved in a direction toward the hollow-out body by an external force, the key cap is pivoted relative to the hollow-out body and contacts the extending arm, such that the extending arm is moved in the direction toward the hollow-out body at the same time.

2. The keyboard button structure of claim 1, wherein a first opening groove is formed between the first support portion and the hollow-out body, and a second opening groove is formed between the second support portion and the hollow-out body.

3. The keyboard button structure of claim 1, wherein the second perpendicular distance is smaller than or equal to the first perpendicular distance.

4. The keyboard button structure of claim 1, wherein the hollow-out body has at least one engaging groove, and the key cap has at least one rotation axis coupled to the engaging groove, such that the key cap is rotatably coupled to the hollow-out body.

5. The keyboard button structure of claim 1, wherein the key cap has a first protruding portion, the first support portion has a first through hole, and the first protruding portion is fixed in the first through hole.

6. The keyboard button structure of claim 5, wherein the key cap has a second protruding portion, the second support portion has a second through hole, and the second protruding portion is fixed in the second through hole.

7. The keyboard button structure of claim 6, wherein the hollow-out body has a plurality of third through holes, and the button structure comprises:
a bottom board having a plurality of third protruding portions; and
a printed circuit board having a plurality of fourth through holes and located between the flexible board and the bottom board, wherein the third protruding portions are coupled to the third and fourth through holes, and when the conducting contact contacts the printed circuit board, a pressing signal is generated by the printed circuit board.

8. The keyboard button structure of claim 1, wherein each of the first and second support portions is substantially U-shaped.

9. The keyboard button structure of claim 1, wherein the hollow-out body, the first and second support portions, and the extending arm are integrally formed as a single piece.

10. The keyboard button structure of claim 1, wherein the flexible board is made of a material that includes copper or stainless steel.

11. The keyboard button structure of claim 1, wherein the key cap is made of a material that includes plastic or metal.
